(19) United States
(12) Patent Application Publication
(10) Pub. No.: US 2024/0066667 A1
(43) Pub. Date: Feb. 29, 2024

(54) Extendable Pronged Pair Of Mandibles Device

(71) Applicant: Eric Smith, Manteca, CA (US)

(72) Inventor: Eric Smith, Manteca, CA (US)

(21) Appl. No.: 17/895,782

(22) Filed: Aug. 25, 2022

(51) Int. Cl. B25B 9/00

(52) U.S. Cl. CPC B25B 9/00

(57) ABSTRACT

An extendable pronged pair of mandibles device for removing animal nests includes a handle base having a top surface, a bottom surface, a pair of side surfaces, a shaft surface, and a button surface. A handle protrudes out from the bottom surface of the handle base. Additionally, a shaft protrudes out from the shaft surface of the handle base. The shaft has a tubular body for nesting an arm with a pair of mandibles having a plurality of teeth for providing grip upon an animal nest. The pair of mandibles further includes a non-magnetic variation for engaging with the animal nest and a magnetic variation for engaging with a plurality of magnetic elements. A trigger is positioned proximate to the handle of the handle base and is a lever being an actuator for the pair of mandibles when pulled towards the handle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to clamp gripping device and more particularly pertains to a new clamp gripping device for removing animal nests.

### (2) Description of Related Art Including Information Disclosed Under 37 CFR 1.97 and 1.98

The prior art relates to clamp gripping devices. The prior art includes a variety of clamp gripping devices comprising a pair of mandibles being engaged by a trigger and handle. Known prior art lacks a clamp gripping device configured for being extendable to remove animal nests by utilizing a variety of elements such as a plurality of lights, an airflow system, pivot controls, and a camera and screen.

### BRIEF SUMMARY OF THE INVENTION

An embodiment of the disclosure meets the needs presented above by generally comprising a handle base having a top surface, a bottom surface, a pair of side surfaces, a shaft surface, and a button surface. A handle protrudes out from the bottom surface of the handle base. Additionally, a shaft protrudes out from the shaft surface of the handle base. The shaft has a tubular body including an interior defining a place for nesting an arm. A pair of mandibles is positioned at an end of the arm, and each of the mandibles has a plurality of teeth configured for providing grip upon an animal nest. The pair of mandibles further includes a non-magnetic variation configured for engaging with the animal nest and a magnetic variation configured for engaging with a plurality of magnetic elements. A trigger is positioned proximate to the handle of the handle base and is a lever configured for being an actuator when pulled towards the handle. The trigger positions the pair of mandibles from a closed position to an open position and vise versa.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an extendable pronged pair of mandibles device according to an embodiment of the disclosure.

FIG. 2 is a left side view of an embodiment of the disclosure.

FIG. 3 is a right view of an embodiment of the disclosure.

FIG. 4 is a top view of an embodiment of the disclosure.

FIG. 5 is a cross-sectional view of an embodiment of the disclosure taken from FIG. 4 of Line 5-5.

FIG. 6 is a detail view of an embodiment of the disclosure.

FIG. 7 is a detail view of an embodiment of the disclosure.

FIG. 8 is an in-use view of an embodiment of the disclosure.

FIG. 9 is an in-use view of an embodiment of the disclosure.

FIG. 10 is a flow chart view of an embodiment of the disclosure.

### DETAILED DESCRIPTION OF THE INVENTION

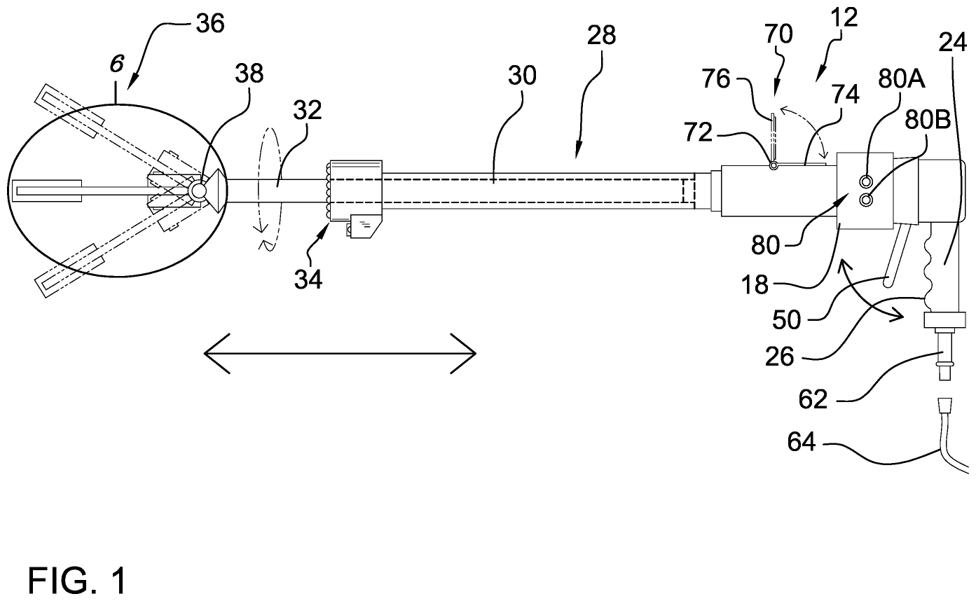

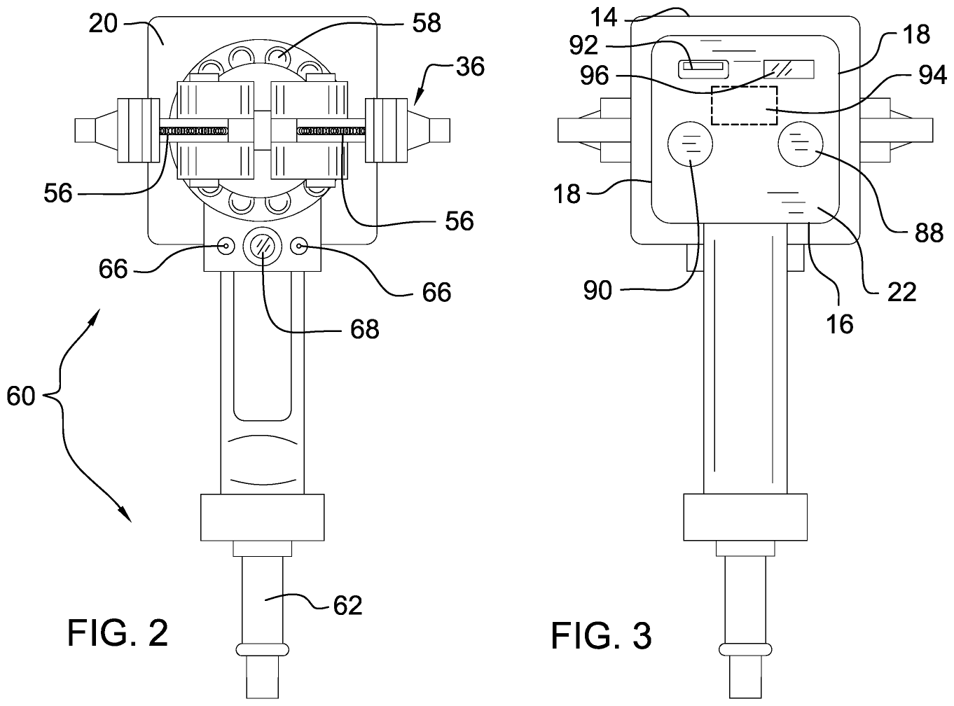

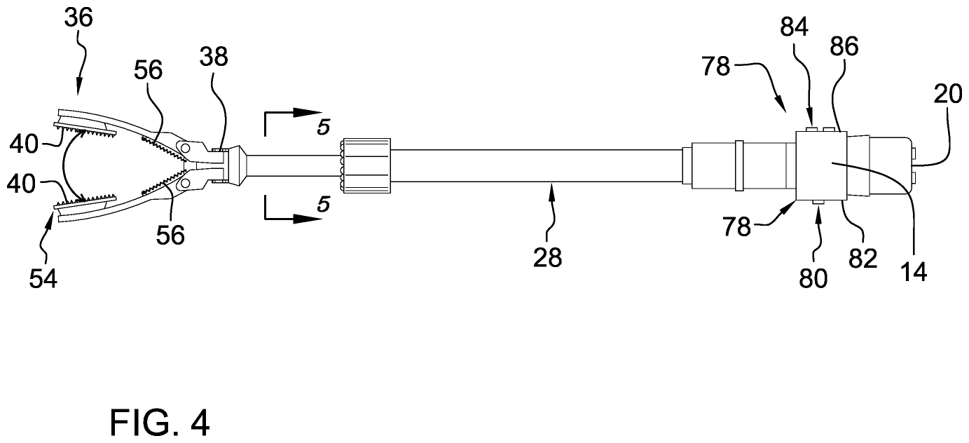

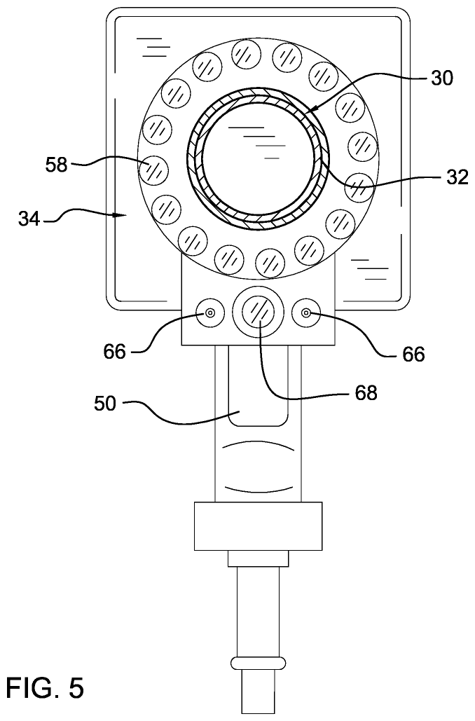

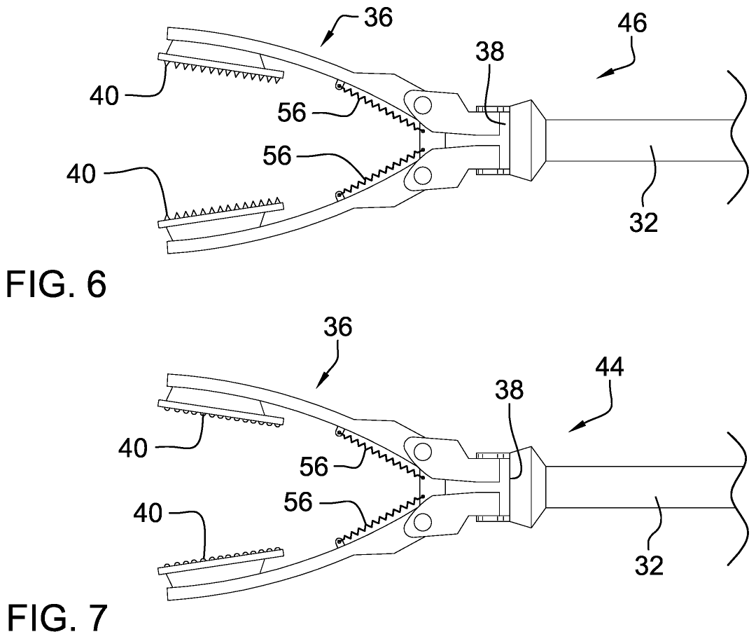

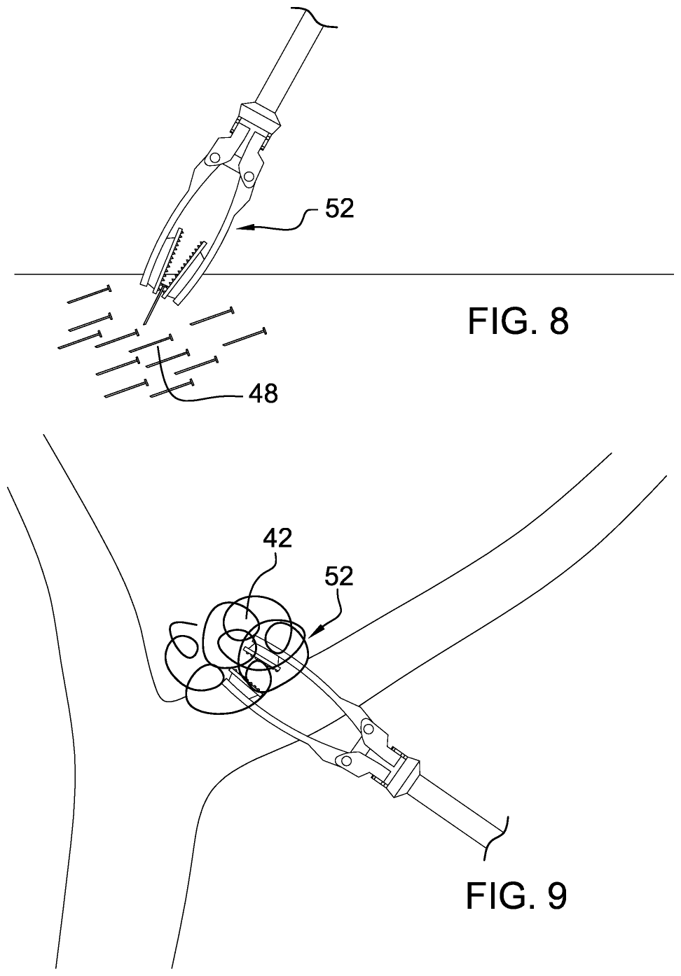

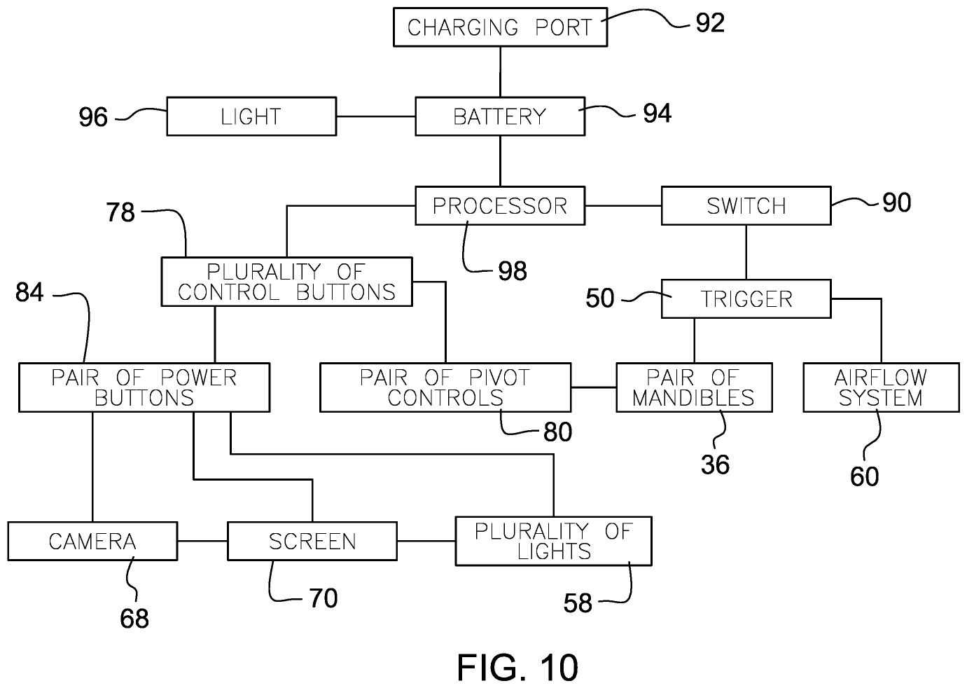

With reference now to the drawings, and in particular to FIGS. 1 through 10 thereof, a new clamp gripping device embodying the principles and concepts of an embodiment of the disclosure and generally designated by the reference numeral 10 will be described.

As best illustrated in FIGS. 1 through 10, the extendable pronged pair of mandibles device 10 generally comprises a handle base 12. The handle base 12 has a top surface 14, a bottom surface 16, a pair of side surfaces 18, a shaft surface 20, and a button surface 22. A handle 24 protrudes out from the bottom surface 16 of the handle base 12 and includes a grip 26 being a plurality of mounds upon the handle 24 configured for providing a grasp for a user. Furthermore, a shaft 28 protrudes out from the shaft surface 20 of the handle base 12. The shaft 20 has a tubular body including an interior 30 defining a place for nesting an arm 32. In addition, the shaft 28 is in a fixed position relative to the arm 32 wherein the arm 32 is extendable from an end 34 of the shaft 28 from four hundred and fifty seven millimeters to eight hundred and twelve millimeters. Moreover, the arm 32 is rotatable within the interior 30 of the shaft 28 such that the arm 32 is able to rotate at a three hundred and sixty degree angle relative to the shaft 28.

A pair of mandibles 36 is positioned at an end of the arm 32. The pair of mandibles 36 is coupled to the end of the arm 32 by a swing plate 38 being configured for pivoting the pair of mandibles 36 up to a ninety degree angle relative to the arm 32. Each of the mandibles 36 has a plurality of teeth 40 configured for providing grip upon an animal nest 42. The pair of mandibles 36 further includes a non-magnetic variation 44 and a magnetic variation 46. The non-magnetic variation 44 is configured for engaging with the animal nest 42 and each of the teeth 40 of the non-magnetic variation 44 has a length being less than three and one hundred seventy five thousandths millimeters. Alternately, the magnetic variation 46 is configured for engaging with a plurality of magnetic elements 48 and each of the teeth 40 of the magnetic variation 46 has a length being greater than the length of each of the teeth 40 of the non-magnetic variation 44 and less than three and one hundred seventy five thousandths millimeters.

A trigger 50 is positioned proximate to the handle 24 of the handle base 12. The trigger 50 is a lever configured for being an actuator when pulled towards the handle 24. The trigger 50 is in mechanical communication with the pair of mandibles 36 wherein the trigger 50 positions the pair of mandibles 36 from a closed position 52 to an open position 54 and vise versa. The trigger 50 is connected to the pair of mandibles 36 by a pair of springs 56 wherein each of the springs 56 is configured for compressing when the trigger 50 is pulled thus positioning the pair of mandibles 36 in the closed position 52. When the trigger 50 is released, each of the springs 56 are decompressed and extended the pair of mandibles 36 into the open position 54.

A plurality of lights 58 is positioned at the end 34 of the shaft 28 in a circle around the arm 32. The plurality of lights 58 is configured for illuminating wherein enhancing visibility upon the pair of mandibles 36. Furthermore, an airflow system 60 is configured for providing and expelling pressurized air upon the pair of mandibles 36. The airflow system 60 is in mechanical communication with the trigger 50 such that the trigger 50 actuates the airflow system 60 when engaged. The airflow system 60 further includes a hose connector 62 is positioned on an end of the handle 24 of the handle base 12. The hose connector 62 is a male connector configured for securing to a female air hose connector 64. Additionally, a pair of nozzles 66 positioned on the end 34 of the shaft 28 is in fluid communication with the hose connector 62 wherein each of the nozzles 66 is configured for expelling pressurized air provided from the hose connector 62. The airflow system 60 is used to move items proximate to the pair of mandibles 36 to reduce the need for the user to engage with the animal nests 42 by hand.

A camera 68 is positioned between the pair of nozzles 66 and is configured for recording visual images facing the pair of mandibles 36. In addition, a screen 70 in electric communication with the camera 68 is positioned on the top surface 14 of the handle base 12 and is configured for showing visual images of the camera 68. The screen 70 has a hinge 72 for positioning the screen 70 from a flat position 74 to a flipped open position 76 relative to the top surface 14. The user can store the screen 70 in the flat position 74 when not in-use. The screen 70 allows to the user see visual images from the camera 68 when using the pair of mandibles 36 is in visually restricted areas.

A plurality of control buttons 78 is positioned on each of the side surfaces 18 of the handle base 12. The plurality of control buttons 78 further includes a pair of pivot controls 80. Each of the pivot controls 80 is a knob being configured for adjusting a positioning of the pair of mandibles 36. The pair of pivot controls 80 is positioned on a left surface 82 of the pair of side surfaces 18. A first pivot control 80A of the pair of pivot controls 80 is used to pivot the pair of mandibles 36 up to a ninety degree angle. A second pivot control 80B of the pair of pivot controls 80 is used to rotate the arm 32 at a three hundred and sixty degree angle relative to the shaft 28. Furthermore, a pair of power buttons 84 is configured for actuating the plurality of lights 58, the screen 70, and the camera 68. The pair of power buttons 84 is positioned on a right surface 86 of the pair of side surfaces 18.

A release button 88 is positioned on the button surface 22 of the handle base 12 and is configured for disengaging the arm 32 with the pair of mandibles 36 from the shaft 28 wherein the pair of mandibles 36 is removable from the shaft 28. The release button 88 is used for interchanging the non-magnetic variation 44 and the magnetic variation 46 within the shaft 28. Furthermore, a switch 90 is positioned on the button surface 22 of the handle base 12, as shown in FIG. 3. The switch 90 is a dial for directing the control of the trigger 50 from the pair of mandibles 36 to the airflow system 60 and vise versa. In-use, the user will position the switch 90 to the left for the trigger 50 to control the airflow system 60, and to the right for the trigger 50 to control the pair of mandibles 36.

A charging port 92 is positioned on the button surface 22 of the handle base 12 and is a universal serial bus port configured for engaging with a power cord. The charging port 92 is in electric communication with a battery 94 and has a light 96 configured for illuminating when the battery 94 is charged with electricity. A processor 98 is in electric communication with the battery 94 and is configured for rendering commands and performing functions of the extendable pronged pair of mandibles device 10. The processor 98 is in electric communication with elements including the plurality of control buttons 78, the switch 90, the battery 94, the trigger 50, the plurality of lights 58, the camera 68, and the screen 70.

In use, the user charges the battery 94 by engaging a power cord with the charging port 92 until the light 96 of the button surface 22 is illuminated. The user can rotate and pivot the pair of mandibles 36 using the pair of pivot controls 80 to position the pair of mandibles 36 in an optimal angle when in-use. By engaging with the trigger 50, the pair of mandibles 36 clamps upon each other to secure an object within the grasp of the pair of mandibles 36. The user can activate the plurality of lights 58 and the camera 68 by using the pair of power buttons 84 to enhance visibility in shaded areas. The female air hose connector 64 can be connected to the hose connector 64 prior to engaging the airflow system 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An extendable pronged clamp device configured for facilitating in the removal of animal nests, the extendable pronged clamp device comprising:
a handle base, said handle base having a top surface and a bottom surface, said handle base having a pair of side surfaces, said handle base having a shaft surface and a button surface;
a handle protruding out from said bottom surface of said handle base;
a shaft protruding out from said shaft surface of said handle base, said shaft having a tubular body including an interior, said interior of said shaft defining a place for nesting an arm;
a pair of mandibles being positioned at an end of said arm, each of said mandibles having a plurality of teeth configured for providing grip upon an animal nest, said pair of mandibles further including:
a non-magnetic variation, said non-magnetic variation being configured for engaging with the animal nest; and
a magnetic variation, said magnetic variation being configured for engaging with a plurality of magnetic elements; and
a trigger being positioned proximate to said handle of said handle base, said trigger being a lever configured for being an actuator when pulled towards said handle, said trigger positioning said pair of mandibles from a closed position to an open position and vise versa.

2. The extendable pronged clamp device of claim 1, further comprising said handle having a grip, said grip being a plurality of mounds upon said handle, said grip being configured for providing a grasp for a user.

3. The extendable pronged clamp device of claim 1, further comprising said shaft being in a fixed position relative to said arm, said arm being extendable from an end of said shaft, said arm being rotatable within said interior of said shaft.

4. The extendable pronged clamp device of claim 3, further said pair of mandibles being coupled to said end of said arm by a swing plate, said swing plate being configured for pivoting said pair of mandibles up to a ninety degree angle relative to said arm.

5. The extendable pronged clamp device of claim 1, further comprising each of said teeth of said non-magnetic variation having a length, said length of each of said teeth of said non-magnetic variation being less than three and one hundred seventy five thousandths millimeters.

6. The extendable pronged clamp device of claim 5, further comprising each of said teeth of said magnetic variation having a length, said length of each of said teeth of said magnetic variation being greater than said length of each of said teeth of said non-magnetic variation, said length of each of said teeth of said magnetic variation being less than three and one hundred seventy five thousandths millimeters.

7. The extendable pronged clamp device of claim 1, further comprising said trigger being in mechanical communication with said pair of mandibles, said trigger being connected to said pair of mandibles by a pair of springs, each of said springs being configured for compressing when said trigger being pulled wherein positioning said pair of mandibles in said closed position.

8. The extendable pronged clamp device of claim 3, further comprising a plurality of lights being positioned at said end of said shaft, said plurality of lights being in a circle around said arm of said end of said shaft, said plurality of lights being configured for illuminating wherein enhancing visibility of said pair of mandibles.

9. The extendable pronged clamp device of claim 1, further comprising an airflow system, said airflow system being configured for providing pressurized air for expelling air upon said pair of mandibles, said airflow system being in mechanical communication with said trigger.

10. The extendable pronged clamp device of claim 9, further comprising a hose connector being positioned on an end of said handle of said handle base, said hose connector being a male connector configured for securing to a female air hose connector.

11. The extendable pronged clamp device of claim 10, further comprising a pair of nozzles positioned on said end of said shaft, each of said nozzles being in fluid communication with said hose connector, each of said nozzles being configured for expelling air from said hose connector.

12. The extendable pronged clamp device of claim 11, further comprising a camera being positioned between said pair of nozzles, said camera being configured for recording visual images, said camera facing said pair of mandibles.

13. The extendable pronged clamp device of claim 12, further comprising a screen being positioned on said top surface of said handle base, said screen being configured for showing visual images of said camera, said screen having a hinge positioning said screen from a flat position to a flipped open position relative to said top surface.

14. The extendable pronged clamp device of claim 4, further comprising a plurality of control buttons being positioned on each of said side surfaces of said handle base, said plurality of control buttons further including a pair of pivot controls, each of said pivot controls being a knob, said pair of pivot controls being configured for adjusting a positioning of said pair of mandibles, said pair of pivot controls being positioned on a left surface of said pair of side surfaces.

15. The extendable pronged clamp device of claim 13, further comprising a pair of power buttons being configured for actuating said plurality of lights and said screen and said camera, said pair of power buttons being positioned on a right surface of said pair of side surfaces;

16. The extendable pronged clamp device of claim 1, further comprising a release button being positioned on said button surface of said handle base, said release button being configured for disengaging said arm of said pair of mandibles from said shaft wherein said pair of mandibles being removable from said shaft;

17. The extendable pronged clamp device of claim 9, further comprising a switch being positioned on said button surface of said handle base, said switch being a dial for directing the control of said trigger for said pair of mandibles to said airflow system and vise versa.

18. The extendable pronged clamp device of claim 1, further comprising a charging port being positioned on said button surface of said handle base, said charging port being a universal serial bus port configured for engaging with a power cord, said charging port being in electric communication with a battery, said charging port having a light, said light being configured for illuminating when said battery being charged.

19. The extendable pronged clamp device of claim 18, further comprising a processor being in electric communication with said battery, said processor being configured for rendering commands and performing functions, said processor being in electric communication with said plurality of control buttons, said switch, said battery, said trigger, said plurality of lights, said camera, and said screen.

20. An extendable pronged clamp device configured for facilitating in the removal of animal nests, the extendable pronged clamp device comprising:
a handle base, said handle base having a top surface and a bottom surface, said handle base having a pair of side surfaces, said handle base having a shaft surface and a button surface;
a handle protruding out from said bottom surface of said handle base, said handle having a grip, said grip being a plurality of mounds upon said handle, said grip being configured for providing a grasp for a user;
a shaft protruding out from said shaft surface of said handle base, said shaft having a tubular body including an interior, said interior of said shaft defining a place for nesting an arm, said shaft being in a fixed position relative to said arm, said arm being extendable from an end of said shaft, said arm being rotatable within said interior of said shaft;
a pair of mandibles being positioned at an end of said arm, said pair of mandibles being coupled to said end of said arm by a swing plate, said swing plate being configured for pivoting said pair of mandibles up to a ninety degree angle relative to said arm, each of said mandibles having a plurality of teeth configured for providing grip upon an animal nest, said pair of mandibles further including:
a non-magnetic variation, said non-magnetic variation being configured for engaging with the animal nest, each of said teeth of said non-magnetic variation having a length, said length of each of said teeth of said non-magnetic variation being less than three and one hundred seventy five thousandths millimeters; and
a magnetic variation, said magnetic variation being configured for engaging with a plurality of magnetic elements, each of said teeth of said magnetic variation having a length, said length of each of said teeth of said magnetic variation being greater than said length of each of said teeth of said non-magnetic variation, said length of each of said teeth of said magnetic variation being less than three and one hundred seventy five thousandths millimeters;
a trigger being positioned proximate to said handle of said handle base, said trigger being a lever configured for being an actuator when pulled towards said handle, said trigger being in mechanical communication with said pair of mandibles, said trigger positioning said pair of mandibles from a closed position to an open position and vise versa, said trigger being connected to said pair of mandibles by a pair of springs, each of said springs being configured for compressing when said trigger being pulled wherein positioning said pair of mandibles in said closed position;
a plurality of lights being positioned at said end of said shaft, said plurality of lights being in a circle around said arm of said end of said shaft, said plurality of lights being configured for illuminating wherein enhancing visibility of said pair of mandibles;
an airflow system, said airflow system being configured for providing pressurized air for expelling air upon said pair of mandibles, said airflow system being in mechanical communication with said trigger, said airflow system further including:
a hose connector being positioned on an end of said handle of said handle base, said hose connector being a male connector configured for securing to a female air hose connector; and
a pair of nozzles positioned on said end of said shaft, each of said nozzles being in fluid communication with said hose connector, each of said nozzles being configured for expelling air from said hose connector;
a camera being positioned between said pair of nozzles, said camera being configured for recording visual images, said camera facing said pair of mandibles;
a screen being positioned on said top surface of said handle base, said screen being configured for showing visual images of said camera, said screen having a hinge positioning said screen from a flat position to a flipped open position relative to said top surface;
a plurality of control buttons being positioned on each of said side surfaces of said handle base, said plurality of control buttons further including:
a pair of pivot controls, each of said pivot controls being a knob, said pair of pivot controls being configured for adjusting a positioning of said pair of mandibles, said pair of pivot controls being positioned on a left surface of said pair of side surfaces; and
a pair of power buttons being configured for actuating said plurality of lights and said screen and said camera, said pair of power buttons being positioned on a right surface of said pair of side surfaces;
a release button being positioned on said button surface of said handle base, said release button being configured for disengaging said arm of said pair of mandibles from said shaft wherein said pair of mandibles being removable from said shaft;
a switch being positioned on said button surface of said handle base, said switch being a dial for directing the control of said trigger for said pair of mandibles to said airflow system and vise versa;
a charging port being positioned on said button surface of said handle base, said charging port being a universal serial bus port configured for engaging with a power cord, said charging port being in electric communication with a battery, said charging port having a light, said light being configured for illuminating when said battery being charged; and
a processor being in electric communication with said battery, said processor being configured for rendering commands and performing functions, said processor being in electric communication with said plurality of control buttons, said switch, said battery, said trigger, said plurality of lights, said camera, and said screen.
